(19) United States
(12) Patent Application Publication
(10) Pub. No.: US 2006/0019051 A1
(43) Pub. Date: Jan. 26, 2006

(54) Method and system for applying a finely registered printed laminated overlay to a substrate

(76) Inventor: Joseph M. Pufahl, Cutchogue, NY (US)

Correspondence Address: DILWORTH & BARRESE, LLP, 333 EARLE OVINGTON BLVD., UNIONDALE, NY, 11553, US

(21) Appl. No.: 11/147,568

(22) Filed: Jun. 8, 2005

Related U.S. Application Data
(60) Provisional application No. 60/578,423, filed on Jun. 9, 2004.

(51) Int. Cl. B32B 33/00; B32B 37/00

(52) U.S. Cl. 428/40.1; 156/268

(57) ABSTRACT

A printed laminated overlay to a substrate includes a first sheet of polymeric material having an adhesive coating and a removable release liner on one side, and another side adhesively bonded to a printed surface of a second sheet of polymeric material, wherein the first sheet of polymeric material is opaque or translucent and has at least one aperture therein. This printed laminated overlay can be applied to a surface of an appliance, electronic device, machinery or vehicle as well as signs, nameplates and the like.

### CROSS REFERENCE TO RELATED APPLICATIONS

This application claims priority to U.S. provisional application Ser. No. 60/578,423 filed Jun. 9, 2004, which is herein incorporated by reference.

### BACKGROUND

1. Field of the Invention

The present invention relates to a method and system for laminating a finely registered overlay using a double coated adhesive system, and applying same to a substrate.

2. Background of the Art

Current technology in this area relies upon printing one or more layers of colored ink (usually white) as a flood coating by screen printing and subsequently drying by convection or ultraviolet (UV) light to produce white background on second surface printed graphics. Such designs are printed primarily on clear polyethylene terephthalate (PET) or polycarbonates (e.g., LEXAN® polycarbonate resin, available from GE Structured Plastics, a division of GE). The graphics and ink printed often require a solid color background to intensify the other printed colors and to provide white areas on which the graphics can be overlaid to provide greater visibility or to incorporate and mask radio frequency identification (RFID) devices under the printed surface.

This process is usually followed by the application of a pressure sensitive adhesive by lamination to allow end users to easily adhere the finished graphic or overlay to different substrates such as the control panels for appliances, electronic devices, machinery or vehicles, as well as signs, nameplates, and the like.

Users may require indicator lamps, LED (light emitting diode) displays or other types of media to be visible without interference by ink or adhesive. For these areas the removal of white or colored sections and adhesive is required.

Presently, adhesive application where certain clear adhesive-free areas are required follows printing and flood coating, this is accomplished by creating a dual liner sheet of the adhesive, die cutting the sheet using a laser or rotary or steel rule dies, removing the excess liner and adhesive, and then removing one layer of release liner and hand registering the resulting die cut sheet to the printed image. Flood coat inks are kept from about 0.010″ to 0.015″ away from the edge of clear areas to allow for mis-registration. Adhesive is often kept at a similar or greater distance to allow for mis-alignment. Off register patterns destroy the workpiece, thereby resulting in undesirable process losses.

What is needed is a lamination process wherein flood coating is eliminated and adhesive application results in accurate fine registration to the printed image.

### SUMMARY

A method for applying a printed laminated overlay to a substrate is provided herein. The method comprises (a) providing a first assembly including (i) a first sheet of polymeric material having a coating of adhesive on each of first and second opposite sides, and (ii) a first release liner disposed along the adhesive coating on the first side of the first sheet of polymeric material and a second release liner disposed along the adhesive coating on the second side of the first sheet of polymeric material; (b) providing a second sheet of synthetic polymeric material having a first surface with indicia printed thereon; (c) adhering a peripheral portion of the first side of the first sheet of polymeric material to a peripheral portion of the first surface of the second sheet of synthetic polymeric material; (d) cutting out and removing at least one selected portion of the first assembly to provide at least one aperture therein; (e) removing the first release liner from the first sheet of polymeric material; and, (f) adhering the remainder of the first side of the first sheet of polymeric material to the first surface of the second sheet of polymeric material to provide the laminated overlay. The method further optionally includes (g) removing the second release liner; and (h) affixing the second side of the first sheet of polymeric material to a substrate.

The flood coating process is eliminated altogether, replacing both ink and adhesive systems with a double sided adhesive coated carrier film. The adhesives on each side can be the same or different. The carrier film can be colored with various degrees of translucency. The method and system described herein provide consistency of coloration and ease of lamination with precise registration.

### BRIEF DESCRIPTION OF THE DRAWINGS

Various embodiments are described below with reference to the drawings wherein:

FIG. 1 is a sectional view of the double coated backing component assembly of the invention;

FIG. 2 is a sectional view illustrating attachment of the backing component to a printed overlay sheet;

FIG. 3 illustrates kiss cutting of the double coated backing component to create windows;

FIGS. 4 and 5 illustrate, respectively, removal of a release liner from the double coated backing component assembly and pressure lamination to the printed overlay sheet to provide a laminated overlay assembly; and,

FIG. 6 is a sectional view illustrating registration and attachment between the laminated overlay assembly to a substrate.

### DETAILED DESCRIPTION OF PREFERRED EMBODIMENT(S)

Referring to FIG. 1, a backing assembly 100 includes a carrier sheet 110 of synthetic polymer such as polyethylene terephthalate (PET) or polypropylene with adhesive layers 120 and 130 attached thereto on opposite sides of the carrier 110. The adhesives 120 and 130 are preferably pressure sensitive adhesives, and may be the same or different types of adhesives. Adhesives suitable for use in the invention are well known in the art. The carrier sheet 110 is preferable colored with a solid color, preferably (and most often) white, and can be opaque or translucent. Carrier sheet 110 provides a solid color background to render the printing of the laminated overlay assembly more visible. A first release liner 150 is attached to one adhesive coated side of the carrier sheet and a second release liner 140 is attached to the opposite adhesive coated side of the liner. Sheet 110 is preferably flexible.

Referring to FIG. 2, a portion of the second liner 140 is removed from peripheral region 102 in the vicinity of the edge of the backing assembly 100, which is adhered to printed overlay sheet 200 (e.g., to a corresponding peripheral region on sheet 200). The peripheral region 102 is typically about ½ inch wide to allow a narrow strip of adhesive to bond to the printed overlay sheet 200. More particularly, overlay sheet 200 includes a surface 220 containing printed graphics, lettering, numerals, signs or other type of indicia and optionally various colors, and a transparent body portion 210. Clear body portion 210 of the overlay sheet 200 is preferably uncolored, but may optionally be tinted, provided that the tinting does not obscure visibility or transparency. Printed overlay sheet 200 is preferably fabricated from a flexible film of PET or polycarbonate resin. The backing assembly 100 is attached to printed surface 220 of the overlay sheet 200. Optionally, printed surface 220 may be provided with areas 221 without any printing, areas 221 being aligned with features of the substrate, as described below.

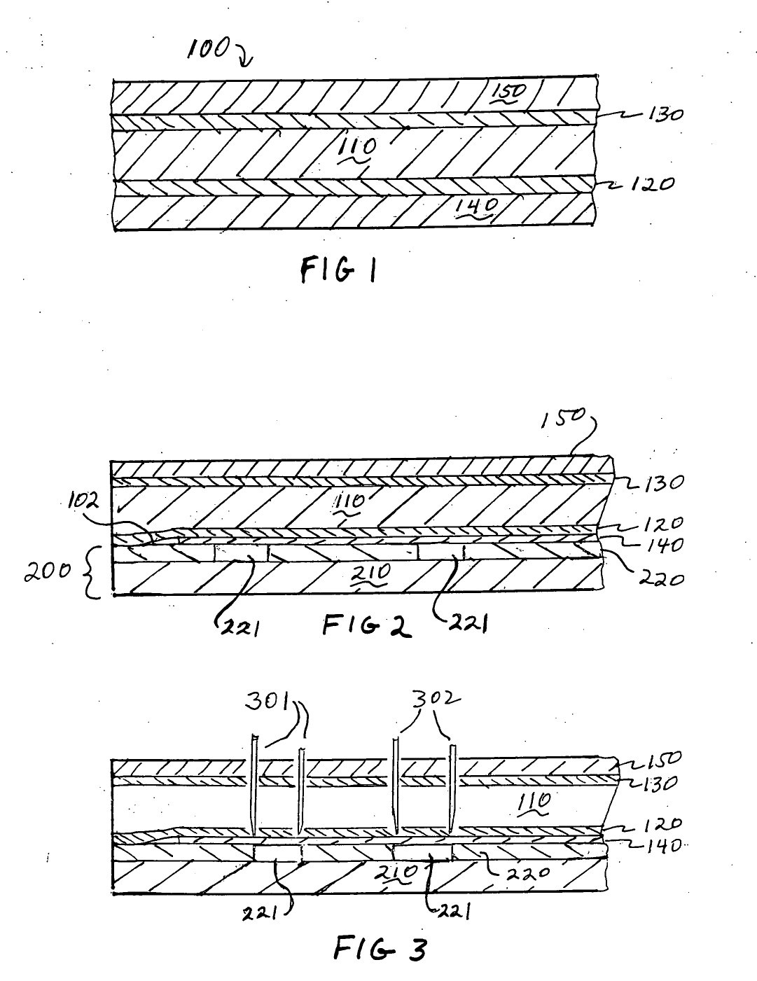

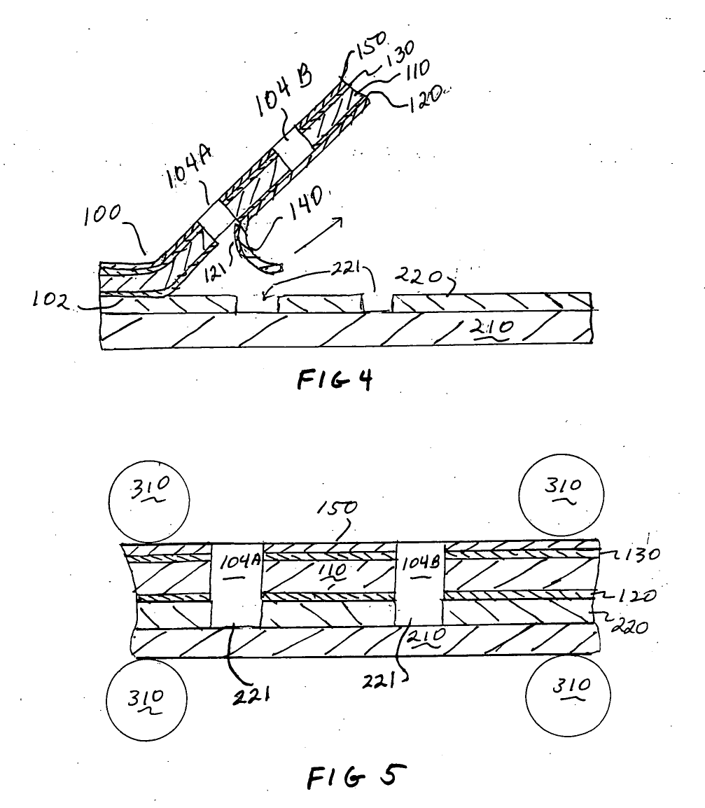

Referring now to FIG. 3, the backing assembly 100 is kiss cut to provide apertures 104A and 104B (FIG. 4). To accomplish the kiss cutting, dies 301 and 302 cut through layers 150, 130, 110 and 120 of the backing assembly, but not release liner 140. The plug sections cut out by the dies 301 and 302 can then be removed to provide the apertures 104A and 104B (FIG. 4). These apertures will be oriented with electronic components or other features of a substrate which require visibility and/or multiple intermittent contacts between the overlay sheet 200 and the substrate, and must not contain white backing or adhesive. As shown herein, the windows are optionally aligned with non-printed areas 221 of the printed sheet 200.

Alternatively, the pattern may be die cut or laser cut all the way through the backing assembly 100. However, this will require a barrier interposed between the backing assembly 100 and the overlay sheet 200 to prevent cutting into the printed surface 220. Kiss cutting is preferred.

Referring now to FIG. 4, the second release liner 140 is removed from the backing assembly 100 taking with it residual portions of any adhesive 120 from windows 104A and 104B.

Referring now to FIG. 5, with second release liner 140 fully removed, the remainder of the backing assembly 100 can then be laminated to the printed overlay sheet 200 by, for example, by pressing together through rollers 310, or by any other suitable means. The pressure sensitive adhesive layer 120 serves as the interface adhesive between the carrier sheet 110 of the backing assembly 100 and the printed surface 220 of the laminated sheet 200 to provide a laminated overlay assembly.

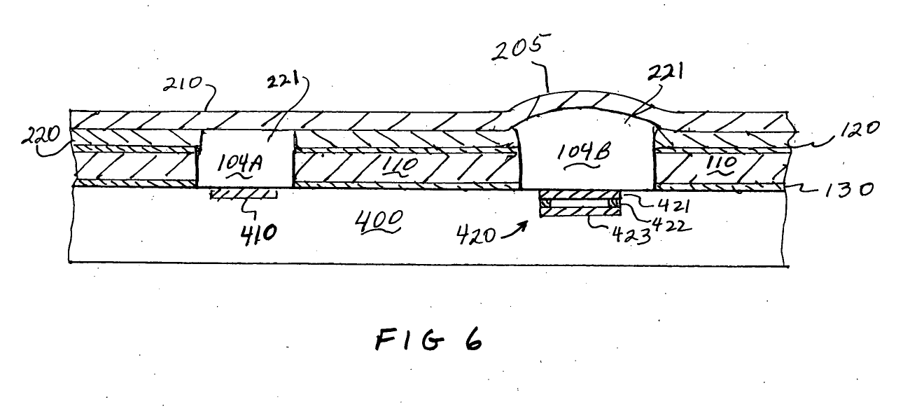

Referring now to FIG. 6, the laminated overlay assembly can be manually applied to a substrate 400 with accurate registration. The substrate can be a control panel for appliances, automobiles, or electronic devices, or the substrate can be a sign, label, nameplate, container, or any other product having a surface to which a printed laminate is to be applied. As shown in FIG. 6, substrate 400 includes a light emitting diode (LED) 410 and a pressure actuated switch 420, both of which require a window such as 104A and 104B. Pressure actuated switch 420 includes an upper electrode layer 421 and a lower electrode layer 423 separated by a spacer 422. When the upper electrode layer 421 is manually pressed into physical contact with the lower electrode layer 423 (e.g., by finger pressing) electrical current is allowed to flow through the switch 420, thereby turning on, or off, or controlling some feature of an appliance or electrically controlled equipment. Other electrically operable devices can also be incorporated into the substrate.

To apply the laminated overlay assembly, the release liner 150 is removed and the pressure sensitive adhesive layer 130 is placed into contact with the surface of the substrate such that windows 104A and 104B are aligned with the appropriate features 410 and 420 of the substrate 400. As can be seen, the carrier sheet 110 is beneath the overlay sheet 200 and provides a white or solid color background for the printing on surface 220. Clear body portion 210 provides a protective cover layer. The printed overlay sheet 200 can be easily provided with convex domed portions 205 to facilitate tactile operation of the devices of the substrate aligned therewith.

While the above description contains many specifics, these specifics should not be construed as limitations of the invention, but merely as exemplifications of preferred embodiments thereof. Those skilled in the art will envision other embodiments within the scope and spirit of the invention as defined by the claims appended hereto.

What is claimed is:

1. A method for applying a laminated overlay to a substrate comprising:
a) providing a first assembly including
(i) a first sheet of polymeric material having a coating of adhesive on each of first and second opposite sides,
(ii) a first release liner disposed along the adhesive coating on the first side of the first sheet of polymeric material and a second release liner disposed along the adhesive coating on the second side of the first sheet of polymeric material;
b) providing a second sheet of synthetic polymeric material having a first surface with indicia printed thereon;
c) adhering a peripheral portion of the first side of the first sheet of polymeric material to a peripheral portion of the first surface of the second sheet of synthetic polymeric material;
d) cutting out and removing at least one selected portion of the first assembly to provide at least one aperture therein;
e) removing the first release liner from the first sheet of polymeric material; and,
f) adhering the remainder of the first side of the first sheet of polymeric material to the first surface of the second sheet of polymeric material to provide the laminated overlay.

2. The method of claim 1 further comprising the steps:
g) removing the second release liner; and
h) affixing the second side of the first sheet of polymeric material to a substrate.

3. The method of claim 1 wherein the substrate includes at least one electrically operable device and the step (h) of affixing the second side of the first sheet of polymeric material to the substrate includes aligning the at least one aperture of the laminated overlay with the at least one electrically operable device.

4. The method of claim 3 wherein the electrically operable device is a switch or a light emitting diode.

5. The method of claim 1 wherein the first sheet of polymeric material is fabricated from polyethylene terephthalate or polypropylene.

6. The method of claim 1 wherein the first sheet of polymeric material is solidly colored and opaque or translucent.

7. The method of claim 6 wherein the first sheet of polymeric material is opaque white.

8. The method of claim 1 wherein the adhesive is a pressure sensitive adhesive.

9. The method of claim 1 wherein the second sheet of polymeric material is fabricated from polyethylene terephthalate or polycarbonate.

10. The method of claim 1 wherein the second sheet of polymeric material is transparent.

11. The method of claim 1 wherein the adhering step (c) comprises removing a portion of the first release liner in the vicinity of at least one edge of the first sheet of polymeric material and affixing the peripheral portion of the first sheet of polymeric material to a portion of the second sheet of polymeric material.

12. The method of claim 1 wherein cutting step (d) comprises cutting through the second release liner and the first sheet of polymeric material to form a plug, and removing the plug to form the aperture.

13. A printed laminated overlay assembly for applying to a substrate, which comprises:
a first sheet of polymeric material having an adhesive coating and a removable release liner on one side, and another side adhesively bonded to a printed surface of a second sheet of polymeric material,
wherein the first sheet of polymeric material is opaque or translucent and has at least one aperture therein.

14. The printed laminated overlay assembly of claim 13 wherein the second sheet of polymeric material is transparent.

15. The printed laminated overlay assembly of claim 13 wherein the first sheet of polymeric material is fabricated from polyethylene terephthalate or polypropylene.

16. The printed laminated overlay assembly of claim 13 wherein the second sheet of polymeric material is fabricated from polyethylene terephthalate or polycarbonate.

17. The printed laminated overlay assembly of claim 13 wherein the adhesive coating comprises a pressure sensitive adhesive.

18. The printed laminated overlay assembly of claim 13 wherein the second sheet of polymeric material includes at least one convex portion aligned with the at least one aperture of the first sheet of polymeric material.

19. The printed laminated overlay assembly of claim 13 wherein the second sheet of polymeric material is tinted.

20. The printed laminated overlay assembly of claim 13 wherein the printed surface of the second sheet of polymeric material includes at least one area with indicia printed thereon and at least one area without indicia printed thereon, said at least one aperture of the first sheet of polymeric material being aligned with the at least one area without indicia printed thereon.
